(19) United States
(12) Patent Application Publication
(10) Pub. No.: US 2026/0167183 A1
(43) Pub. Date: Jun. 18, 2026

(54) SAFETY-ASSISTANT CONTROL METHOD AND APPARATUS

(71) Applicants: Hyundai Motor Company, Seoul (KR); Kia Corporation, Seoul (KR)

(72) Inventor: Woo Sung Lee, Hwaseong-si (KR)

(21) Appl. No.: 19/384,780

(22) Filed: Nov. 10, 2025

(30) Foreign Application Priority Data
Dec. 12, 2024 (KR) 10-2024-0184336

(51) Int. Cl. B60W 30/09; B60W 10/04; B60W 10/18

(52) U.S. Cl. CPC B60W 30/09; B60W 10/04; B60W 10/18; B60W 2420/54; B60W 2510/1005; B60W 2510/18; B60W 2540/10; B60W 2540/12; B60W 2554/4041; B60W 2710/18

(57) ABSTRACT

In certain examples, a method may include determining whether a vehicle is in a state of willing to drive based on a state of a driving controller, a braking controller, and a gear; determining whether a rear seat door is opened, when the vehicle is in the state of willing to drive; determining whether a dynamic obstacle exists, when the rear seat door is opened; and setting a value of a drive stop flag differently depending on whether the rear seat door is opened and the dynamic obstacle exists. When the value of the drive stop flag includes a first value, the driving controller inactivates driving of the vehicle, and the braking controller activates braking of the vehicle, and, when the value of the drive stop flag includes a second value, the driving controller activates driving of the vehicle, and the braking controller inactivates braking of the vehicle.

### CROSS-REFERENCE TO RELATED APPLICATIONS

This application claims priority to and the benefit of Korean Patent Application No. 10-2024-0184336 filed with the Korean Intellectual Property Office on December 12, 2024, the entire contents of which is incorporated herein by reference.

### TECHNICAL FIELD

The present disclosure relates to a safety-assistant control method and apparatus.

### BACKGROUND

When a driver gets into a vehicle and starts off, or stops the vehicle and then starts off again, the driver may not be fully aware of the situation in the rear seat, which may lead to an accident. In particular, if a rear seat occupant picks up an object with the door open or the vehicle starts while people are getting on or off, there is a high possibility that a serious accident will occur. In addition, if the driver takes out an object from the back seat and places it next to the vehicle without checking it before driving off, there is a risk of a collision with the object. In the case of existing vehicles, it is difficult to prevent this risk because the vehicle is designed to move when the driver shifts the transmission to drive (D) gear or lifts the driver’s foot off the brake while the rear door is open. A situation where a driver starts the vehicle without recognizing that a person is moving while the rear door is open can lead to a serious accident, so technological improvements are needed to prevent this.

### SUMMARY

The present disclosure attempts to provide a safety-assistant control method and apparatus allowing the system to intervene in vehicle operation in the event of a rear-side situation (e.g., door opening and dynamic obstacle existence) of the vehicle that is difficult for the driver to recognize.

A safety-assistant control method, which may be performed by a computing device implemented in a vehicle, and include a processor and a memory, may include determining, by the processor, whether the vehicle is in a state of willing to drive based on a state of a driving controller, a braking controller, and a gear, determining, by the processor, whether a rear seat door is opened, when it is determined that the vehicle is in the state of willing to drive, determining, by the processor, whether a dynamic obstacle exists, when it is determined that the rear seat door is opened, and setting, by the processor, a value of a drive stop flag differently depending on whether the rear seat door is opened and whether the dynamic obstacle exists, where, when the value of the drive stop flag may include a first value, the driving controller inactivates driving of the vehicle, and the braking controller activates braking of the vehicle, and where, when the value of the drive stop flag may include a second value different from the first value, the driving controller activates driving of the vehicle, and the braking controller inactivates braking of the vehicle.

The determining whether the vehicle is in the state of willing to drive may include determining, by the processor, that the vehicle is in the state of willing to drive, when the gear-stage is in a D range, and a driving command is transmitted from an accelerator pedal to the driving controller.

The determining whether the vehicle is in the state of willing to drive may include determining, by the processor, that the vehicle is in the state of willing to drive, when the gear-stage is in a D range, and a transmission of a braking command from a brake pedal to the driving controller is stopped.

The determine whether the rear seat door is opened may include receiving, by the processor, an opening signal of the rear seat door of the vehicle from a door controller, and determining, by the processor, whether the rear seat door is opened based on the value of the opening signal.

The determining whether the dynamic obstacle exists may include detecting, by the processor, the dynamic obstacle around the vehicle by using an ultrasonic wave sensor and a surround view monitor (SVM) module.

The detecting the dynamic obstacle may include detecting an obstacle from a sensing result of the ultrasonic wave sensor, detecting a motion of the obstacle by an SVM module, and determining, by the processor, that the dynamic the obstacle has been detected around the vehicle, when the motion of the obstacle detected by the ultrasonic wave sensor is detected by the SVM module.

The detecting the obstacle from the sensing result of the ultrasonic wave sensor may include identifying a location of the detected obstacle in grid coordinates, by analyzing the sensing result of the ultrasonic wave sensor based on grids.

The detecting the motion of the obstacle by the SVM module may include detecting whether grid coordinates regarding the obstacle is changed to other coordinates within a predetermined time, based on a grid in the same specification as the grid used for the ultrasonic wave sensor.

The safety-assistant control method may further include initializing, by the processor, a driving command transmitted from the accelerator pedal to the driving controller, when the value of the drive stop flag may include the first value, and an accelerator pedal is pressed.

The safety-assistant control method may further include transmitting, by the processor, a braking command to the braking controller, when the value of the drive stop flag may include the first value, and a brake pedal is pressed and then released.

A safety-assistant control apparatus implemented in a vehicle may include one or more non-transitory computer-readable media including an instruction, and one or more processors configured to perform an operation by executing the instruction, where the operation may include determining whether the vehicle is in a state of willing to drive based on a state of a driving controller, a braking controller, and a gear, determining whether a rear seat door is opened, when it is determined that the vehicle is in the state of willing to drive, determining whether a dynamic obstacle exists, when it is determined that the rear seat door is opened, and setting a value of a drive stop flag differently depending on whether the rear seat door is opened and whether the dynamic obstacle exists, where, when the value of the drive stop flag may include a first value, the driving controller inactivates driving of the vehicle, and the braking controller activates braking of the vehicle, and where, when the value of the drive stop flag may include a second value different from the first value, the driving controller activates driving of the vehicle, and the braking controller inactivates braking of the vehicle.

The determining whether the vehicle is in the state of willing to drive may include determining, by the processor, that the vehicle is in the state of willing to drive, when the gear-stage is in a D range, and a driving command is transmitted from an accelerator pedal to the driving controller.

The determining whether the vehicle is in the state of willing to drive may include determining, by the processor, that the vehicle is in the state of willing to drive, when the gear-stage is in a D range, and a transmission of a braking command from a brake pedal to the driving controller is stopped.

The determining whether the rear seat door is opened may include receiving, by the processor, an opening signal of the rear seat door of the vehicle from a door controller, and determining, by the processor, whether the rear seat door is opened based on the value of the opening signal.

Where the determining whether the dynamic obstacle exists may include detecting, by the processor, the dynamic the obstacle around the vehicle by using an ultrasonic wave sensor and a surround view monitor (SVM) module.

The detecting the dynamic the obstacle may include detecting the obstacle from a sensing result of the ultrasonic wave sensor, detecting a motion of the obstacle by an SVM module, and when the motion of the obstacle detected by the ultrasonic wave sensor is detected by the SVM module, determining, by the processor, that the dynamic the obstacle has been detected around the vehicle.

The detecting the obstacle from the sensing result of the ultrasonic wave sensor may include identifying a location of the detected obstacle in grid coordinates, by analyzing the sensing result of the ultrasonic wave sensor based on grids.

The detecting the motion of the obstacle by the SVM module may include detecting whether grid coordinates regarding the obstacle is changed to other coordinates within a predetermined time, based on a grid in the same specification as the grid used for the ultrasonic wave sensor.

Where the operation may include initializing a driving command transmitted from the accelerator pedal to the driving controller, when the value of the drive stop flag may include the first value, and an accelerator pedal is pressed, and transmitting a braking command to the braking controller, when the value of the drive stop flag may include the first value, and a brake pedal is pressed and then released.

One or more non-transitory computer-readable media including an instruction executable by a computing device is provided, where the instruction causes the computing device to perform the operation when executed by one or more processors of the computing device, and where the operation may include determining whether the vehicle is in a state of willing to drive based on a state of a driving controller, a braking controller, and a gear, determining whether a rear seat door is opened, when it is determined that the vehicle is in the state of willing to drive, determining whether a dynamic obstacle exists, when it is determined that the rear seat door is opened, and setting a value of a drive stop flag differently depending on whether the rear seat door is opened and whether the dynamic obstacle exists, where, when a value of the drive stop flag may include a first value, the driving controller inactivates driving of the vehicle, and the braking controller activates braking of the vehicle, and where, when the value of the drive stop flag may include a second value different from the first value, the driving controller activates driving of the vehicle, and the braking controller inactivates braking of the vehicle.

### BRIEF DESCRIPTION OF THE DRAWINGS

FIG. 1 is a drawing for explaining a safety-assistant control apparatus according to an embodiment.

FIG. 2 and FIG. 3 are drawings for explaining an implementation example of a safety-assistant control method and apparatus according to an embodiment.

FIG. 4 is a drawing for explaining a safety-assistant control method according to an embodiment.

FIG. 5 is a drawing for explaining a computing device according to an embodiment.

### DETAILED DESCRIPTION OF ILLUSTRATIVE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, when a part "includes" a certain element, it means that other elements may be further included, rather than excluding other elements, unless otherwise stated. Terms including ordinal numbers such as first, second, and the like will be used only to describe various constituent elements, and are not to be interpreted as limiting these constituent elements. The terms are only used to differentiate one constituent element from other constituent elements.

In addition, terms such as "... part," "... portion," " ... er/or," or "module" disclosed in the present specification may mean a unit that may process at least one function or operation described in this specification, and this may be implemented by hardware, software, or a combination thereof. Additionally, at least some of the configurations or functions of a safety-assistant control method and apparatus according to the embodiments described below may be implemented as a program or software, and the program or software may be stored in a computer-readable medium.

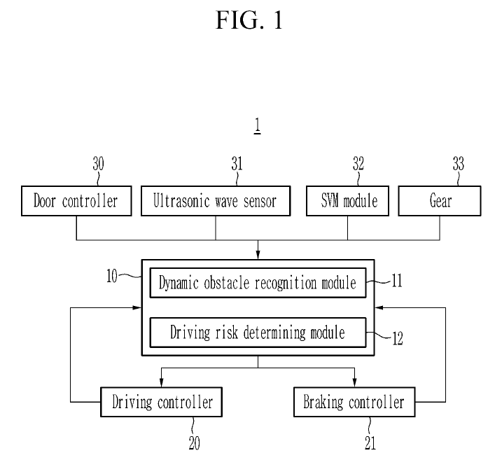

FIG. 1 is a drawing for explaining a safety-assistant control apparatus according to an embodiment.

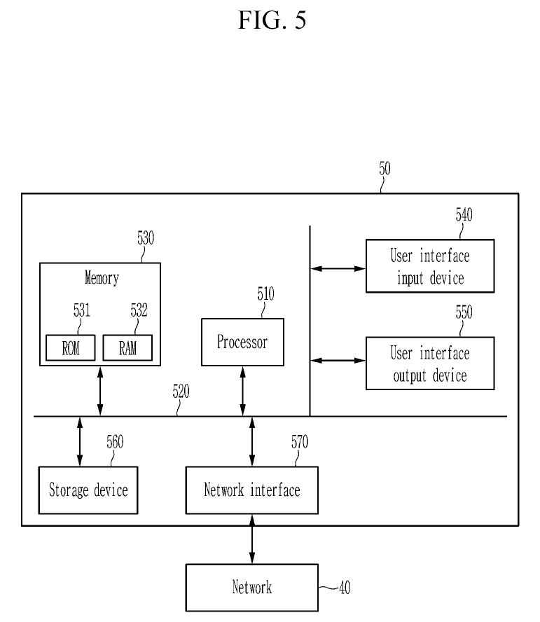

Referring to FIG. 1, a safety-assistant control apparatus 10 according to an embodiment may be implemented as a computing device including a processor and memory. For example, a connection device for the vehicle and an external device may be implemented as a computing device 50, described later in connection with FIG. 5. Here, the computing device 50 may be implemented in a vehicle 1, for example, implemented as a controller mounted on the vehicle 1. In this case, one or more processors may correspond to a processor 510 of the computing device 50, and one or more memory devices may correspond to a memory 530 of the computing device 50. Alternatively, in some embodiments, a safety-assistant control apparatus 10 may include one or more non-transitory computer-readable media including an instruction and one or more processors configured to perform an operation by executing the instruction. Here, the operation may include configurations, functions, steps, or the like described in this specification with respect to a safety-assistant control method and apparatus according to embodiments. In this specification, the term "module" is used in order to logically differentiate these operations performed by the safety-assistant control method and apparatus according to embodiments.

The safety-assistant control apparatus 10 may be implemented within the vehicle 1. The safety-assistant control apparatus 10 may exchange data with other devices implemented together within the vehicle 1, for example, at least one of a driving controller 20, a braking controller 21, a door controller 30, an ultrasonic wave sensor 31, a surround view monitor (SVM) module 32 and a gear 33 through an internal network. In some embodiments, internal network may include a controller area network (CAN), a local interconnect network (LIN), and an automotive ethernet, or the like. The vehicle integration controller 20 may be a device that comprehensively manages and controls various systems installed in the vehicle 1.

The safety-assistant control apparatus 10 may determine whether the vehicle 1 is in a state of willing to drive, based on the state of the driving controller 20, the braking controller 21, and the gear 33. Specifically, when the stage of the gear 33 is the D range, and a driving command is transmitted from an accelerator pedal to the driving controller 20, the safety-assistant control apparatus 10 may determine that the vehicle 1 is in the state of willing to drive. In addition, even when the stage of the gear 33 is the D range, and the transmission of a braking command from a brake pedal to the driving controller 20 is stopped, the safety-assistant control apparatus 10 may determine that the vehicle 1 is in the state of willing to drive.

When it is determined that the vehicle is in the state of willing to drive, a dynamic obstacle recognition module 11 of the safety-assistant control apparatus 10 may determine whether a rear seat door is opened. Specifically, the dynamic obstacle recognition module 11 may receive opening signals of rear seat doors RL and RR of the vehicle from the door controller 30, and may determine whether the rear seat door is opened based on the value of the opening signal.

When it is determined that the rear seat door is opened, the dynamic obstacle recognition module 11 may determine whether a dynamic obstacle exists. Specifically, the dynamic obstacle recognition module 11 may detect a dynamic obstacle around the vehicle by using the ultrasonic wave sensor 31 and the SVM module 32.

In some embodiments, in order to detect the dynamic obstacle, the dynamic obstacle recognition module 11 may detect the obstacle from a sensing result of the ultrasonic wave sensor 31, and may detect a motion of the obstacle by the SVM module 32. When the motion of the obstacle detected by the ultrasonic wave sensor 31 is detected by the SVM module 32, the dynamic obstacle recognition module 11 may determine that the dynamic obstacle has been detected around the vehicle 1.

In some embodiments, in order to detect the obstacle from the sensing result of the ultrasonic wave sensor 31, the dynamic obstacle recognition module 11 may identify the location of the detected obstacle in grid coordinates by analyzing the sensing result of the ultrasonic wave sensor 31 based on the grid. Meanwhile, in order to detect the motion of the obstacle by the SVM module 32, the dynamic obstacle recognition module 11 may detect whether grid coordinates regarding the corresponding obstacle is changed to other coordinates within a predetermined time, based on a grid in the same specification as the grid used for the ultrasonic wave sensor 31.

A driving risk determining module 12 of the safety-assistant control apparatus 10 may set a value of a drive stop flag differently depending on whether the rear seat door is opened and whether the dynamic obstacle exists. Specifically, when the value of the drive stop flag includes a first value, the driving controller 20 may inactivate driving of the vehicle 1, and the braking controller 21 may activate braking of the vehicle 1. Alternatively, when the value of the drive stop flag includes a second value different from the first value, the driving controller 20 may activate driving of the vehicle 1, and the braking controller 21 may inactivate braking of the vehicle 1.

In some embodiments, when the value of the drive stop flag includes the first value, and the accelerator pedal is pressed, the driving risk determining module 12 may initialize the driving command transmitted from the accelerator pedal to the driving controller 20.

In some embodiments, when the value of the drive stop flag includes the first value, and the brake pedal is pressed and then released, the driving risk determining module 12 may transmit the braking command to the braking controller 21.

According to the present embodiment, when a driver attempts to start off without being aware of a rear seat or a rear-side situation of the vehicle due to carelessness, an accident can be effectively prevented by introducing a system that determines this as a dangerous situation and blocks the driving (starting) of the vehicle and displays a warning.

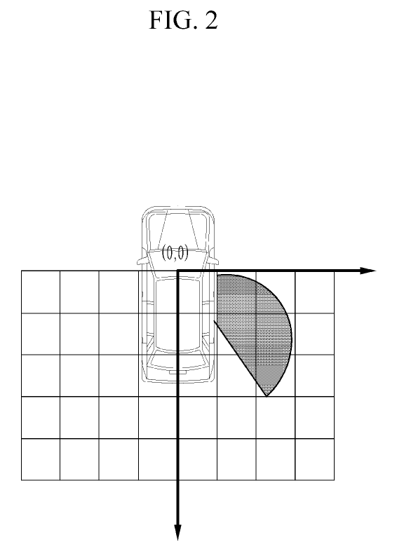

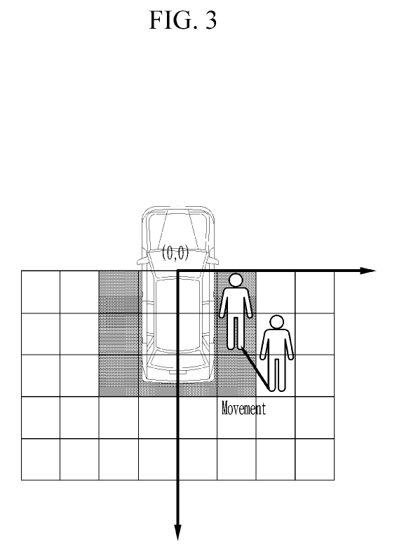

FIG. 2 and FIG. 3 are drawings for explaining an implementation example of a safety-assistant control method and apparatus according to an embodiment.

Referring to FIG. 2, by using the ultrasonic wave sensor, the rear and the rear-side of the vehicle can be gridded into units of, for example, 30 cm, and the location can be represented in the form of coordinates based on the detection result of the ultrasonic wave sensor. In this way, the vehicle's surroundings can be finely divided and the presence of obstacles in each region can be detected in real time. For example, as a detection result, when it is determined that the obstacle exists in the grid from (1, 0) to (3, 3), this may be converted into coordinates.

Referring to FIG. 3, by utilizing SVM, the same as with the ultrasonic wave sensor, the rear and rear-side of the vehicle may be gridded into the units of 30 cm, and the movement of the obstacle in that region may be detected. When the grid location of the obstacle detected by the SVM result changes, for example, for 3 seconds, this may be determined as a dynamic obstacle. For example, when the obstacle has moved from (2, 1) to (3, 3) grid to (1, 0) to (2, 2) grid, this may mean that the obstacle has moved within that grid, and when it moves within or enters a shaded box range, this may be recognized as a dynamic obstacle.

As such, by performing location comparison of the grid of the location of the obstacle obtained as shown in FIG. 2, and the grid with movement obtained as shown in FIG. 3, it may be determined whether it is a driving risk situation.

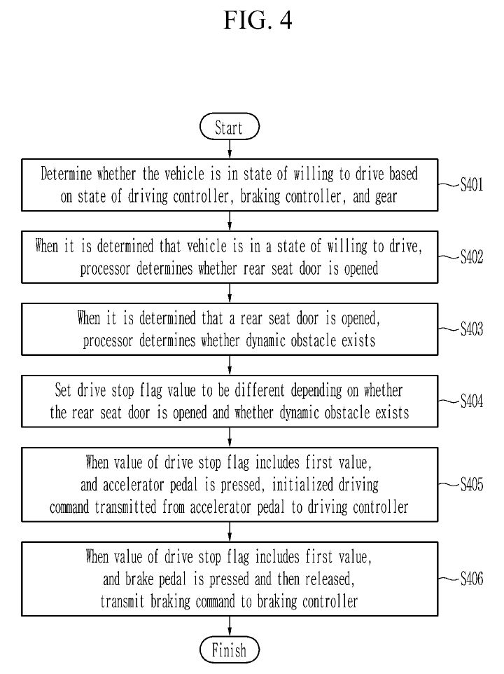

FIG. 4 is a drawing for explaining a safety-assistant control method according to an embodiment.

Referring to FIG. 4, a safety-assistant control method according to an embodiment may perform a step S401 of determining whether the vehicle is in the state of willing to drive based on the state of the driving controller, the braking controller, and the gear, a step S402 of determining, by processor, whether the rear seat door is opened, when it is determined that the vehicle is in the state of willing to drive, a step S403 of determining whether the dynamic obstacle exists when it is determined that the rear seat door is opened, a step S404 of setting the value of the drive stop flag differently depending on whether the rear seat door is opened and whether the dynamic obstacle exists, a step S405 of initializing the driving command transmitted from the accelerator pedal to the driving controller when the value of the drive stop flag includes the first value, and the accelerator pedal is pressed, and a step S406 of transmitting the braking command to the braking controller when the value of the drive stop flag includes the first value, and the brake pedal is pressed and then released.

For more detailed information about the above method, reference can be made to the description of the embodiments described in this specification, so a redundant description is omitted here.

FIG. 5 is a diagram showing a computing device according to an exemplary embodiment.

Referring to FIG. 5, a safety-assistant control method and apparatus may be implemented using the computing device 50. The computing device 50 may be implemented as various types of electronic devices, servers or similar devices, and its function may be implemented through a combination of software and hardware.

The computing device 500 may include at least one of a processor 510, a memory 530, a user interface input device 540, a user interface output device 550 and a storage device 560 that communicate with each other through a bus 520. The computing device 50 may include a network interface 570 electrically connected to a network 40. The network interface 570 may send or receive signals to and from other entities through the network 40.

The processor 510 may be implemented as various types of calculation devices, such as a microcontroller unit (MCU), an application processor (AP), a central processing unit (CPU), a graphic processing unit (GPU), a neural processing unit (NPU), a quantum processing unit (QPU), etc. The processor 510 is also a semiconductor device that executes instructions stored in the memory 530 or the storage device 560 and may play a key role in the system. Program codes and data stored in the memory 530 or the storage device 560 instruct the processor 510 to perform specific tasks, thereby enabling the overall operation of the system. In this way, the processor 510 may implement the various functions and methods described above with reference to FIGS. 1 to 4.

The memory 530 and storage device 560 may include various forms of volatile or non-volatile storage medium for storing and accessing data of the system. For example, the memory 530 may include a read-only memory (ROM) 531 and a random-access memory (RAM) 532. In some embodiments, the memory 530 may be built into the processor 510, in which case data transmission speeds between the memory 530 and the processor 510 may be very fast. In some other embodiments, the memory 530 may be disposed external to the processor 510, in which case the memory 530 may be connected to the processor 510 through various data buses or interfaces. This connection may be made through a variety of known means, for example, a peripheral component interconnect express (PCIe) interface for high-speed data transmission or a memory controller.

In some embodiments, at least some components or functions of a safety-assistant control method and apparatus according to the embodiments may be implemented as a program or software executed by the computing device 50, and the program or software may be stored on the computer-readable recording medium or storage medium. In detail, the computer-readable recording medium or storage medium according to an embodiment may have a program recorded for executing steps included in the implementation of a safety-assistant control method and apparatus according to the embodiments that is recoded on a computer including the processor 510 executing the program or the instruction, stored in the memory 530 or the storage device 560.

In some embodiments, at least some components or functions of a safety-assistant control method and apparatus according to the embodiments may be implemented using the hardware or circuitry of the computing device 50, or implemented using a separate hardware or circuitry that may be electrically connected to the computing device 50.

In some embodiments, one or more non-transitory computer-readable media including an instruction executable by the computing device 50 may be provided, and the instruction may cause the computing device 50 to perform the operation, when executed by one or more processors of the computing device 50. Here, the operation may include configurations, functions, steps, or the like described in this specification in connection with safety-assistant control method and apparatus according to embodiments.

According to an embodiment, when a driver attempts to start off without being aware of a rear seat or a rear-side situation of the vehicle due to carelessness, an accident can be effectively prevented by introducing a system that determines this as a dangerous situation and blocks the driving (starting) of the vehicle and displays a warning.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A safety-assistant control method, being performed by a computing device implemented in a vehicle, and comprising a processor and a memory, the safety-assistant control method comprising:
determining, by the processor, whether the vehicle is in a state of willing to drive based on a driving controller state of a driving controller, a braking controller state of a braking controller, and a gear state of a gear;
determining, by the processor, whether a rear seat door is opened, when it is determined that the vehicle is in the state of willing to drive;
determining, by the processor, whether a dynamic obstacle exists, when it is determined that the rear seat door is opened; and
setting, by the processor, a value of a drive stop flag differently depending on whether the rear seat door is opened and whether the dynamic obstacle exists,
wherein:
when the value of the drive stop flag comprises a first value, the driving controller inactivates driving of the vehicle, and the braking controller activates braking of the vehicle, and
when the value of the drive stop flag comprises a second value different from the first value, the driving controller activates driving of the vehicle, and the braking controller inactivates braking of the vehicle.

2. The safety-assistant control method of claim 1, wherein:
determining whether the vehicle is in the state of willing to drive comprises determining, by the processor, that the vehicle is in the state of willing to drive, when the gear state is in a D range, and a driving command is transmitted from an accelerator pedal to the driving controller.

3. The safety-assistant control method of claim 1, wherein:
determining whether the vehicle is in the state of willing to drive comprises determining, by the processor, that the vehicle is in the state of willing to drive, when the gear state is in a D range, and a transmission of a braking command from a brake pedal to the driving controller is stopped.

4. The safety-assistant control method of claim 1, wherein determining whether the rear seat door is opened comprises:
receiving, by the processor, an opening signal of the rear seat door of the vehicle from a door controller; and
determining, by the processor, whether the rear seat door is opened based on the value of the opening signal.

5. The safety-assistant control method of claim 1, wherein:
determining whether the dynamic obstacle exists comprises detecting, by the processor, the dynamic obstacle around the vehicle by using an ultrasonic wave sensor and a surround view monitor (SVM) module.

6. The safety-assistant control method of claim 5, wherein detecting the dynamic obstacle comprises:
detecting an obstacle from a sensing result of the ultrasonic wave sensor;
detecting a motion of the obstacle by an SVM module; and
determining, by the processor, that the dynamic obstacle has been detected around the vehicle, when the motion of the obstacle detected by the ultrasonic wave sensor is detected by the SVM module.

7. The safety-assistant control method of claim 6, wherein:
detecting the obstacle from the sensing result of the ultrasonic wave sensor comprises identifying a location of the detected obstacle in grid coordinates, by analyzing the sensing result of the ultrasonic wave sensor based on a grid.

8. The safety-assistant control method of claim 7, wherein:
detecting the motion of the obstacle by the SVM module comprises detecting whether the grid coordinates corresponding to the obstacle are changed to other coordinates within a predetermined time, based on a grid in a same specification as the grid used for the ultrasonic wave sensor.

9. The safety-assistant control method of claim 1, further comprising:
initializing, by the processor, a driving command transmitted from an accelerator pedal to the driving controller, when the value of the drive stop flag comprises the first value, and the accelerator pedal is pressed.

10. The safety-assistant control method of claim 1, further comprising:
transmitting, by the processor, a braking command to the braking controller, when the value of the drive stop flag comprises the first value, and a brake pedal is pressed and then released.

11. A safety-assistant control apparatus implemented in a vehicle, the safety-assistant control apparatus comprising:
one or more processors; and
one or more non-transitory computer-readable media comprising instructions which, when executed by the one or more processors, cause the one or more processors to:
determine whether the vehicle is in a state of willing to drive based on a driving controller state of a driving controller, a braking controller state of a braking controller, and a gear state of a gear;
determine whether a rear seat door is opened, when it is determined that the vehicle is in the state of willing to drive;
determine whether a dynamic obstacle exists, when it is determined that the rear seat door is opened; and
set a value of a drive stop flag differently depending on whether the rear seat door is opened and whether the dynamic obstacle exists,
wherein:
when the value of the drive stop flag comprises a first value, the driving controller inactivates driving of the vehicle, and the braking controller activates braking of the vehicle, and
when the value of the drive stop flag comprises a second value different from the first value, the driving controller activates driving of the vehicle, and the braking controller inactivates braking of the vehicle.

12. The safety-assistant control apparatus of claim 11, wherein, to determine whether the vehicle is in the state of willing to drive, execution of the instructions by the one or more processors further causes the one or more processors to:
determine that the vehicle is in the state of willing to drive, when the gear state is in a D range, and a driving command is transmitted from an accelerator pedal to the driving controller.

13. The safety-assistant control apparatus of claim 11, wherein, to determine whether the vehicle is in the state of willing to drive, execution of the instructions by the one or more processors further causes the one or more processors to:
determine that the vehicle is in the state of willing to drive, when the gear state is in a D range, and a transmission of a braking command from a brake pedal to the driving controller is stopped.

14. The safety-assistant control apparatus of claim 11, wherein, to determine whether the rear seat door is opened, execution of the instructions by the one or more processors further causes the one or more processors to:
receive an opening signal of the rear seat door of the vehicle from a door controller; and
determine whether the rear seat door is opened based on the value of the opening signal.

15. The safety-assistant control apparatus of claim 11, wherein, to determine whether the dynamic obstacle exists, execution of the instructions by the one or more processors further causes the one or more processors to:
detect an obstacle around the vehicle by using an ultrasonic wave sensor and a surround view monitor (SVM) module.

16. The safety-assistant control apparatus of claim 15, wherein, to detect the dynamic obstacle, execution of the instructions by the one or more processors further causes the one or more processors to:
detect the obstacle from a sensing result of the ultrasonic wave sensor;
detect a motion of the obstacle by an SVM module; and
when the motion of the obstacle detected by the ultrasonic wave sensor is detected by the SVM module, determine that the dynamic obstacle has been detected around the vehicle.

17. The safety-assistant control apparatus of claim 16, wherein, to detect the obstacle from the sensing result of the ultrasonic wave sensor, execution of the instructions by the one or more processors further causes the one or more processors to:
identify a location of the detected obstacle in grid coordinates, by analyzing the sensing result of the ultrasonic wave sensor based on a grid.

18. The safety-assistant control apparatus of claim 17, wherein, to detect the motion of the obstacle by the SVM module, execution of the instructions by the one or more processors further causes the one or more processors to:
detect whether grid coordinates regarding the obstacle is changed to other coordinates within a predetermined time, based on a grid in a same specification as the grid used for the ultrasonic wave sensor.

19. The safety-assistant control apparatus of claim 11, wherein execution of the instructions by the one or more processors further causes the one or more processors to:
initialize a driving command transmitted from an accelerator pedal to the driving controller, when the value of the drive stop flag comprises the first value, and the accelerator pedal is pressed; and
transmit a braking command to the braking controller, when the value of the drive stop flag comprises the first value, and a brake pedal is pressed and then released.

20. One or more non-transitory computer-readable media comprising an instruction executable by a computing device, the instruction causing the computing device to perform an operation when executed by one or more processors of the computing device, wherein the operation comprises:
determining whether a vehicle is in a state of willing to drive based on a driving controller state of a driving controller, a braking controller state of a braking controller, and a gear state of a gear;
determining whether a rear seat door is opened, when it is determined that the vehicle is in the state of willing to drive;
determining whether a dynamic obstacle exists, when it is determined that the rear seat door is opened; and
setting a value of a drive stop flag differently depending on whether the rear seat door is opened and whether the dynamic obstacle exists,
wherein, when the value of the drive stop flag comprises a first value, the driving controller inactivates driving of the vehicle, and the braking controller activates braking of the vehicle, and
wherein, when the value of the drive stop flag comprises a second value different from the first value, the driving controller activates driving of the vehicle, and the braking controller inactivates braking of the vehicle.
